(19) United States
(12) Patent Application Publication
(10) Pub. No.: US 2015/0148162 A1
(43) Pub. Date: May 28, 2015

(54) TRANSMISSION PULLEY, POWER TRANSMISSION SYSTEM COMPRISING SUCH A PULLEY, AND METHOD FOR PRODUCING SUCH A PULLEY

(71) Applicants: Charles Chambonneau, Joue les Tours (FR); Samuel Viault, Saint-Antoine-du-Rocher (FR)

(72) Inventors: Charles Chambonneau, Joue les Tours (FR); Samuel Viault, Saint-Antoine-du-Rocher (FR)

(73) Assignee: AKTIEBOLAGET SKF, Goteborg (SE)

(21) Appl. No.: 14/556,064

(22) Filed: Nov. 28, 2014

(30) Foreign Application Priority Data
Nov. 27, 2013 (FR) 1361699

(51) Int. Cl. F16H 55/42; B23P 15/14; F02B 67/06; F16H 55/49; F16H 7/02

(52) U.S. Cl. CPC F16H 55/42; F16H 55/49; F16H 7/023; F02B 67/06; B23P 15/14
USPC 474/148; 474/168; 29/892.11

(57) ABSTRACT

A transmission pulley, for a power transmission system including a belt having longitudinal grooves, having at least one end cap, a stack (E) of identical crowns, as well as means of connecting the crowns and the cap, parallel to a rotational axis (X10) of the pulley and rotating about this axis. The cap defines a hollow housing wherein half of the adjacent crown is engaged on one side of a median plane of the crown.

### FIELD OF THE INVENTION

The invention concerns a transmission pulley, as well as a power transmission system including a belt with longitudinal grooves, and such a transmission pulley. Lastly, the invention concerns a method for producing such a pulley.

### BACKGROUND OF THE INVENTION

In the field of automobile engines in particular, it is known to use belt-based power transmission systems having a belt that circulates on transmission pulleys around a freewheel, a carrier roller, or a shaft that may drive a compressor, alternator, or equivalent material that may be actuated by a crankshaft or mounted so as to rotate freely. To increase the maximum power transmitted between a pulley and the belt circulating around the pulley, it is known to use a belt having longitudinal grooves, most frequently having a V-shaped cross-section, whilst the belt itself has elevations that complement these longitudinal grooves, which, in practice, also define grooves for receiving longitudinal elevations of the belt.

Depending on the power to be transmitted, the conditions of use of a power transmission system, various belt widths may be used, requiring the production of pulleys of different widths. This necessitates the provision of different production ranges and the management of different pulleys both in terms of supply and storage of finished products. This is relatively complex and increases the cost price of the power transmission systems having belts with longitudinal grooves. It is these disadvantages that the invention particularly seeks to remedy by proposing a novel transmission pulley for such systems, the production of which is simplified and the cost price of which is decreased compared to prior-art pulleys.

To this end, the invention concerns a transmission pulley for a power transmission system including a belt with longitudinal grooves. This pulley comprises at least one end cap, a stack of identical crowns, as well as means of connecting the crowns and the cap, parallel to a rotational axis of the pulley and rotating about this axis. According to the invention, the cap defines a hollow housing in which half of the adjacent crown is engaged on one side of a median plane of this crown.

Due to the invention, the width of the pulley, i.e., in practical terms, the number of elevations intended to cooperate with the longitudinal grooves of the belt associated with the pulley, may be adjusted by adding more or fewer identical crowns in the stack of the pulley. Thus, with a single type of end cap and a single type of crown, it is possible to form pulleys having variable widths and numbers of grooves, giving the pulley according to the invention a substantial capacity to adapt to its environment. Because of the reception of half of a crown into the hollow housing of the cap, a robust and axially compact pulley is obtained.

### SUMMARY OF THE INVENTION

According to aspects of the invention that are advantageous, but not obligatory, such a pulley may include one or more of the following characteristics, taken in any technically permissible combination:
It comprises two end caps, between which the stack of identical crowns is arranged, in a direction parallel to the rotational axis of the pulley, whereas each cap defines a hollow housing for receiving one half of an adjacent crown and whereas the halves of these crowns received in the housings are opposite.
The two end caps are identical.
Each crown comprises, on a first surface, at least one projecting elevation and, on a second surface opposite the first surface, at least one housing for a projecting elevation of a crown adjacent to the stack.
The end cap comprises, on a surface orientated towards the stack of identical crowns, a coding elevation identical to that provided on one surface of the crown of the stack that is nearest to the cap, whereby this surface is orientated in the opposite direction to the cap.
The means of connection comprise at least one axial clamping member of the end cap and the stack of identical crowns, in particular a rivet or bolt.
The means of connection comprise a quantity of glue or solder arranged between the cap and the stack of identical crowns, and/or between the crowns.
Together, two adjacent crowns define a groove for receiving a tooth of the belt at the level of their respective external peripheries.

The invention further concerns a power transmission system, in particular for a rotating part of an automobile engine, comprising a belt having longitudinal grooves as well as rotary pulleys, at least one of which is of the type described above.

Lastly, the invention concerns a method for producing a transmission pulley for a power transmission system as described above, comprising the following steps:
a) determining the number of longitudinal grooves of the belt,
b) forming a stack of identical crowns with a number of crowns selected depending on the number of grooves of the belt, and
c) connecting the stack of crowns with at least one end cap.

### BRIEF DESCRIPTION OF THE DRAWINGS

The invention will be better understood, and other advantages will become clearer in the light of the following description of four embodiments of a pulley according to the invention, a power transmission system comprising such a pulley, and a method for producing such a pulley also according to the invention, provided by way of example only and by reference to the attached drawings, in which:

FIG. 1 is an exploded perspective view of a pulley according to a first embodiment of the invention;

FIG. 2 is a semi-exploded perspective view of the pulley of FIG. 1;

FIG. 3 is a perspective view of the pulley of FIGS. 1 and 2 in its mounted configuration;

FIG. 4 is an axial section of the pulley in the configuration of FIG. 3 along the line IV-IV of FIG. 3;

FIG. 5 is a view analogous to FIG. 4 of a pulley according to a second embodiment of the invention;

FIG. 6 is a view analogous to FIG. 4 of a pulley according to a third embodiment of the invention; and

FIG. 7 is a view analogous to FIG. 4 of a pulley according to a fourth embodiment of the invention.

### DETAILED DESCRIPTION OF THE INVENTION

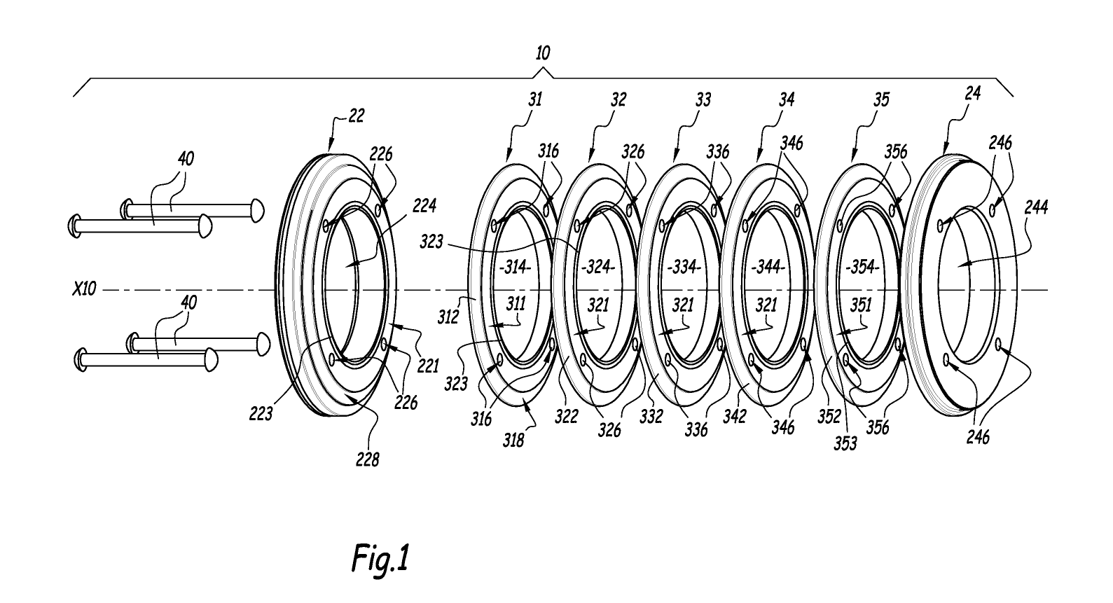

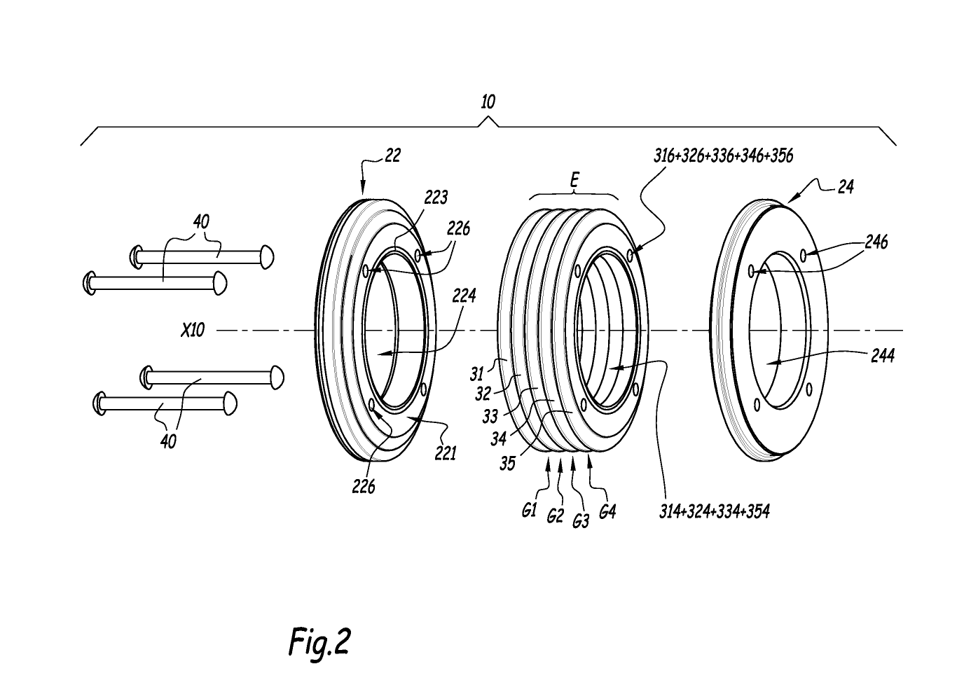

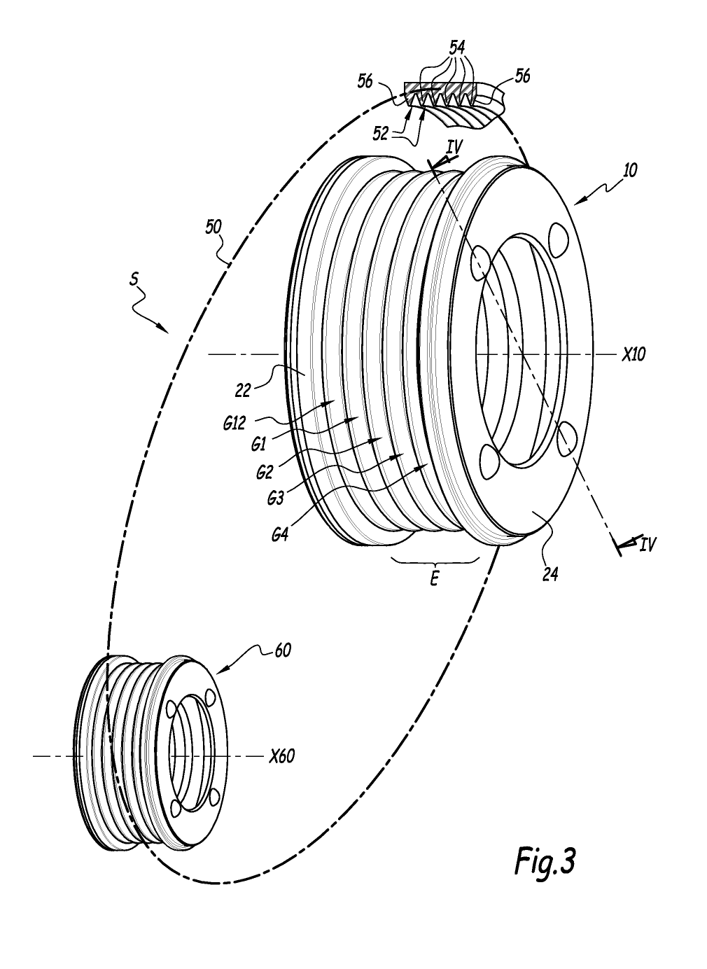

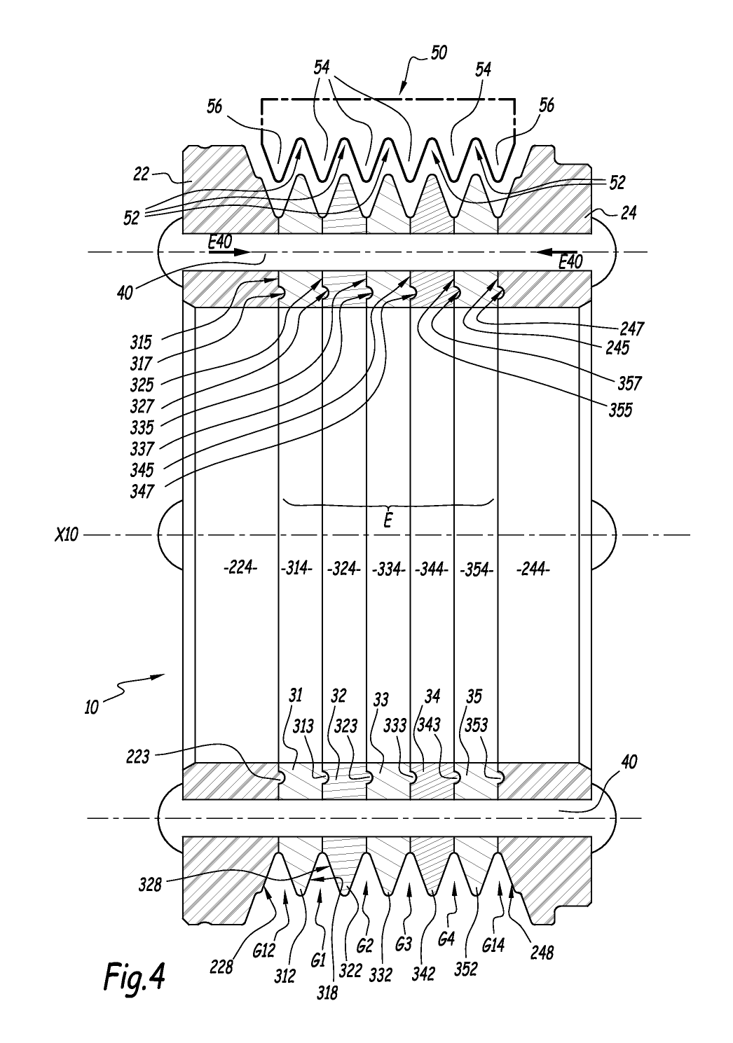

The pulley 10 shown in FIGS. 1-4 is provided to turn around an axis X10, mounted on a support such as a freewheel, a carrier roller, or a shaft (not shown). The pulley 10 comprises a first cap 22 and a second cap 24, annular in shape, centered on the axis X10 in the mounted configuration of the pulley 10, delimiting the ends of the pulley 10 along the axis X10. In other words, the cap 22 constitutes a first axial end along the axis X10 of the pulley 10 on the left in FIGS. 3 and 4, whilst the cap 24 defines a second, opposite axial end of the pulley 10, on the right in these drawings. Between the caps 22 and 24 and along the axis X10, five crowns 31, 32, 33, 34, and 35 are arranged, which are identical to one another and consecutive to one another along the axis X10 in this order, from the cap 22 to the cap 24.

The crown 31 comprises a radial, external peripheral edge 312 having an overall triangular section. The crown 31 further comprises a central reaming 314 centered on the axis X10 in the mounted configuration of the pulley 10, and which has the same dimensions as the respective central reamings 124 and 244 of the caps 22 and 24.

Furthermore, the pulley 10 comprises four rivets 40 that engage in corresponding openings arranged respectively in the caps 22 and 24 and the crowns 31 and 35. The openings of the caps 22 and 24 in which the rivets 40 fit have the references 226 and 246, whilst the openings of the crown 31 in which the rivets 40 fit have the reference 316.

The crowns 32-35 are identical to the crown 31; they respectively have radial and external peripheral edges 322, 332, 342, and 352, central reamings 324, 334, 344 and 354, and openings 326, 336, 346, and 356, which are traversed by the rivets 40.

When they are coupled with one another according to the axis X10, the crowns 31-35 form a stack E, and their edges 312-352, together, define four grooves G1, G2, G3, and G4.

More specifically, as can be seen in FIGS. 3 and 4, the pulley 10 is provided to cooperate with a belt 50 that defines five longitudinal grooves 52 having a V-shaped cross-section, two adjacent grooves 52 that are separated by a tip 54, whilst two lateral 56 abut the grooves 52 arranged on the sides of the belt 50.

For clarity, the belt 50 is shown partially in FIG. 3 and as a dotted line only on the top in FIG. 4. This belt 50, along with the pulley 10, is part of a power transmission system S, shown in a highly schematic fashion in FIG. 3, and which comprises, in addition to the pulley 10 and the belt 50, a second pulley 60 shown at a smaller scale than the pulley 10, and which rotates about an axis X60 parallel to axis X10. In FIGS. 3 and 4, to allow for the visualisation of the grooves 52, the belt 50 is shown separately from the pulley 10. In practice, in the operating configuration of the system S, the pulley 50 lies against the pulley 10.

It will be noted that each of the grooves G1-G4 is V-shaped, complementing a tip 54 of the belt 50. The groove G1 is defined by a first surface 318 of the edge 312, and a second surface 328 of the edge 322, which diverge from one another with increasing distance from the axis X10. Likewise, each of the grooves G2-G4 is defined between two divergent surfaces of the edges of the crowns 32-35, between which this groove is defined. To allow for effective transmission of power between the belt 50 and the pulley 10, the number and geometry of the grooves G1-G4 is adapted to the number and geometry of the tips 54 of the belt 50.

Furthermore, the pulley 10 defines two lateral grooves G12 and G14, which serve to receive the edges 56 of the belt 50. The grooves G12 and G14 are respectively defined between the edge 312 of the crown 31 and an inclined surface 228 of the cap 22, and between the edge 352 and an inclined surface 248 of the cap 24.

In practice, the cross-section of the edges 56 is identical to that of the tips 54, and the grooves G12 and G14 have the same geometry as the grooves G1-G4. However, this is not obligatory.

The flat lateral surface of the crown 31 visible in FIG. 1 can be seen 311. The crown 31 has a peripheral bead 313 that surrounds the reaming 314 and is elevated relative to the surface 311. Furthermore, the flat lateral surface of the crown 31 can be seen 315, which is not visible in FIG. 1, a trace of which is visible in FIG. 4. The surface 315 has a peripheral groove 317 having a geometry that complements that of the bead 313.

Because the crowns 32-35 are identical to the crown 31, they each have beads 323, 333, 343, and 353, and grooves 327, 337, 347, and 357, respectively on their lateral surfaces 321, 331, 341, 351, 325, 335, 345, and 355. Furthermore, the cap 22 has a peripheral bead 223, whilst the cap 24 has a peripheral edge 247 on their surfaces 221 and 245, each facing the stack E.

The stack E is formed by engaging the beads 313, 323, 333, and 343 respectively in the grooves 327, 337, 347, and 357. These beads and grooves thus allow for the formation of a mechanical coding system ensuring the correct orientation of the crowns 31-35 within the stack E. If applicable, this allows for the formation of grooves G1-G4 having asymmetric sections. These grooves allow for the crowns, and thus the V shapes, to be centered relative to one another, ensuring optimal coaxiality.

When the stack E is formed, it is possible to place the caps 22 and 24 on either side of it along the axis X10 by inserting the bead 123 into the groove 317 and the bead 353 into the groove 247.

When the two caps are arranged in this manner on either side of the stack E, it suffices to align the openings 226, 316, 326, 336, 346, 356, and 246 before inserting the rivets 40 into the openings and crimping the rivets in place. The rivets then immobilise the elements 22, 24, and 31-35 relative to one another, parallel to the axis X10 and rotating about the axis. The relative immobilisation of the caps 22 and 24 and the stack E is obtained by an axial clamping force E40 parallel to the axis X10 exerted by the rivets 40 on the caps.

This results in the configuration of FIGS. 3 and 4, in which the pulley 10 is formed with a geometry adapted to that of the belt 50.

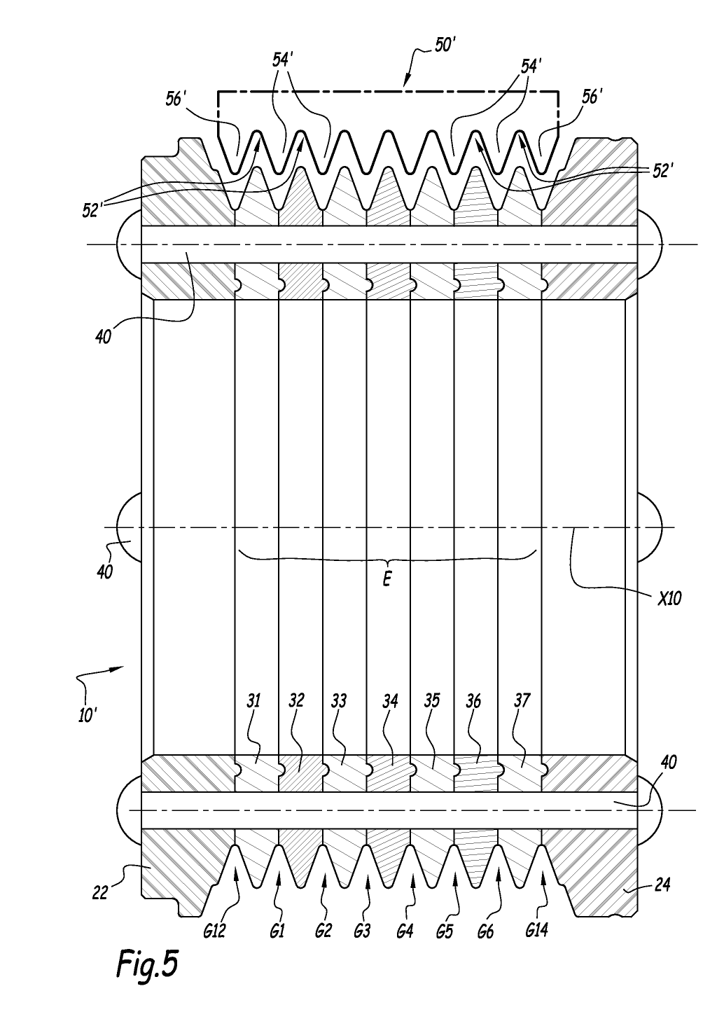

If one wishes to use a belt 50′ as shown in the top of FIG. 5, defining seven longitudinal grooves 52′, the number of crowns of the stack E reaches seven using two additional crowns 36 and 37 relative to the embodiment of FIGS. 1-4. Otherwise, the method of producing the pulley 10′ shown in FIG. 5 is comparable to that of the pulley 10 shown in FIGS. 1-4.

In this case, the pulley 10′ comprises six grooves G1-G6 corresponding to the grooves G1-G4 of the first embodiment, as well as two lateral grooves G12 and G14.

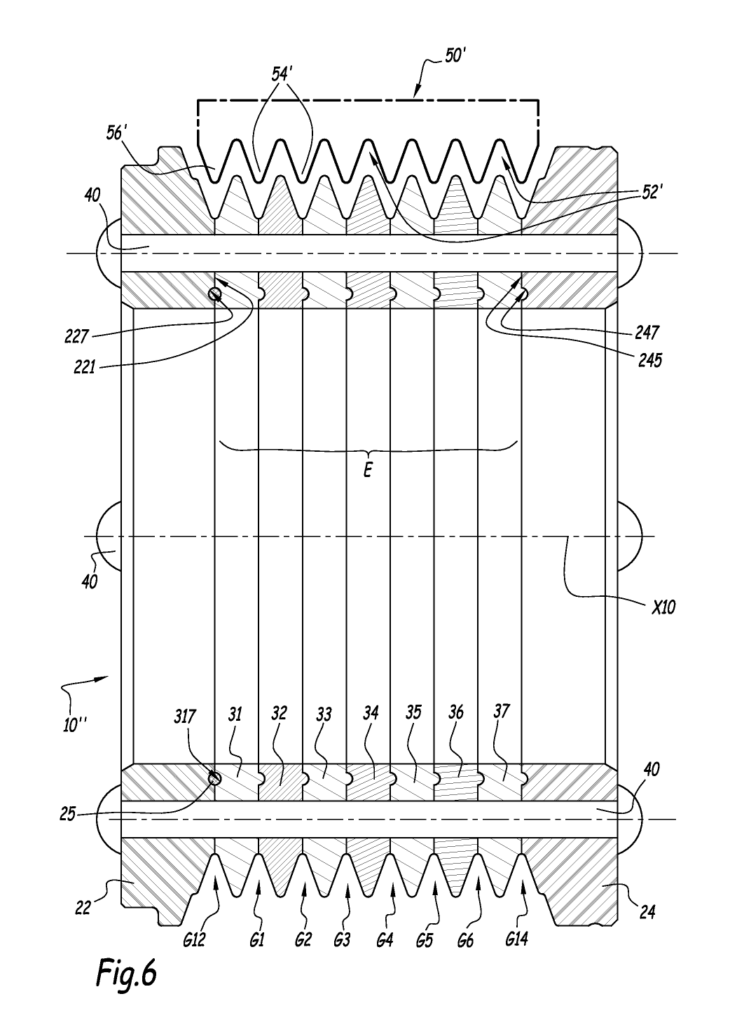

As shown with the pulley 10″ of the embodiment of FIG. 6, which is meant to cooperate with the belt 50′ used with the pulley 10′, the caps 22 and 24 may be identical. The cap 22 has on its surface 221 facing the stack E a groove 227 identical to the groove 247 arranged on the surface 225 of the cap 24. An O-ring 25 is engaged simultaneously in the grooves 227 and 317, which are aligned about the axis X10.

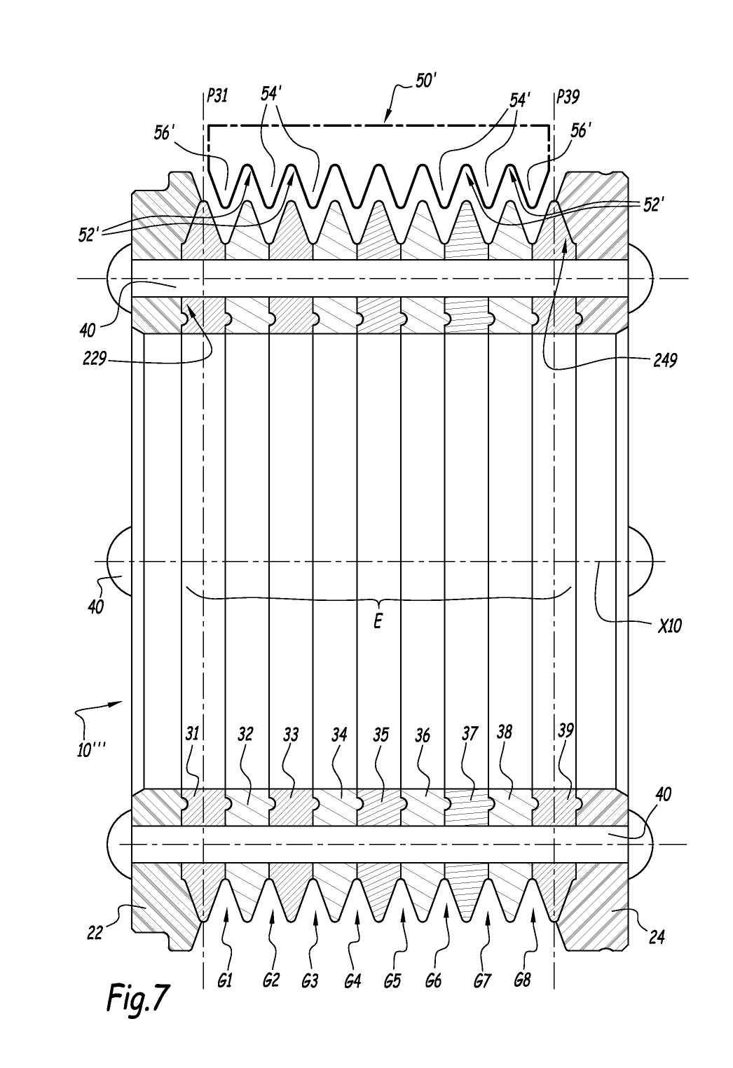

As shown with the pulley 10″' of the embodiment of FIG. 7, which is meant to cooperate with the belt 50′ used with the pulleys 10′ and 10″, the grooves meant to receive the edges 56′ of the belt 50′ may be defined between two crowns of the stack E, which here comprises nine crowns 31-39. The grooves G1-G8 arranged within the stack E thus receive the six tips 54′ and the two edges 56′ of the belt 50′. To this end, the caps 22 and 24 are configured so as to accommodate part of the first and second crowns 31 and 39 of the stack E.

More specifically, the cap 22 defines a hollow housing 229 in which half of the crown 31 is engaged on one side of a median plane P31 of the crown that is equidistant from its lateral surfaces and perpendicular to the axis X10. Likewise, the cap 24 defines a housing 249 for receiving half of the crown 39 on one side of a median plane P39 of this crown. The halves of the crowns 31 and 39 received in the housings 31 and 39 are opposite.

This embodiment avoids direct contact between the belt 50 and the caps 22 and 24, which are advantageously made of synthetic material.

In one variant, the partial incorporation of a terminal crown of the stack in the adjacent cap only occurs on one side of the stack, either adjacent to the cap 22 or adjacent to the cap 24.

Whatever the embodiment, by selecting the number of crowns 31 and equivalents in the stack E depending on the number of longitudinal grooves 52 or 52′ of the belt 50 or 50′ used, it is possible to adapt the geometry of each pulley 10, 10′, or 10″ to the belt with which it will cooperate within a power transmission system S by proceeding with a single set of detached pieces, i.e., the caps 22 and 24, on the one hand, and the crowns 31 et seq., which are identical to one another, on the other hand. In practice, the number of crowns in the stack E is equal to the number of grooves 52 or 52′ of the pulley, decreased by one unit in the first three embodiments, and to the number of grooves increased by one unit in the fourth embodiment.

The number of grooves of a pulley according to the invention is not limited to that of the examples, and it may be adapted based on the number of crowns of the stack E.

In one variant, if the geometry of the belt 50 requires, the lateral grooves G12 and G14 of the first three embodiments may have a different cross-section to the other grooves of the pulley.

In one variant, other means of axial connection of the elements 22, 24, and 31-35 or 31-37 may be used rather than the rivets 40, in particular bolts or quantities of glue. In one variant, depending on the material from which they are made, the caps and crowns may be soldered together.

To ensure the solidity of the pulley 10, 10′, or 10″ according to the invention, the assembly of the caps and crowns is preferably irreversible.

The caps 22 and 24 are preferably made of synthetic material, whilst the crowns 31 and equivalent are made of metal. In one variant, the caps are made of metal and/or the crowns are made of synthetic material.

According to one variant of the invention (not shown), a single cap 22 or 24 is provided in the pulley according to the invention. In fact, a single end cap suffices to ensure a guiding function of the belt 50 or 50′ and the coding of its axial position along the axis X10.

The invention has been shown in the case in which the crowns 31 and caps 22 together define V-shaped grooves. Other geometries are conceivable, in particular in which the surfaces 228, 248, 318, and 328 are not flat, depending on the geometry of the belt 50 or 50′.

The embodiments and variants discussed above may be combined to generate new embodiments of the invention.

1. A transmission pulley for a power transmission system including a belt having longitudinal grooves, comprising:
at least one end cap,
a stack (E) of identical crowns,
means of connecting crowns and the cap, parallel to a rotational axis (X10) of the pulley and rotating about this axis, wherein
the cap defines a hollow housing in which half of the adjacent crown is engaged on one side of a median plane of this crown.

2. The pulley according to claim 1, further comprising two end caps between which the stack (E) of identical crowns is arranged in a direction parallel to the rotational axis (X10) of the pulley, wherein
each cap defines a hollow housing for receiving one half of an adjacent crown, and wherein
the halves of the crowns received in the housings are opposite.

3. The pulley according to claim 2, wherein the two end caps are identical.

4. The pulley according to claim 1, wherein each crown provides, on a first surface, at least one projecting elevation, and, on a second surface opposite the first surface, at least one housing for a projecting elevation of a crown adjacent to the stack (E).

5. The pulley according to claim 4, wherein the end cap provides, on a surface orientated towards the stack (E) of identical crowns, a coding elevation identical to that provided on one surface of the crown of the stack that is nearest to the cap, wherein the surface is orientated in the opposite direction to the cap.

6. The pulley according to claim 1, wherein the means of connection includes at least one axial clamping member of the end cap and the stack (E) of identical crowns, in particular one of a rivet and bolt.

7. The pulley according to claim 1, wherein the means of connection includes one of a quantity of glue and solder arranged between the cap and the stack (E) of identical crowns; and between the crowns.

8. The pulley according to claim 1, wherein two adjacent crowns together define, at the level of their respective external peripheries, a groove for receiving one tooth of the belt.

9. The power transmission system (S) for a rotating part of an automobile engine, comprising:
a belt having longitudinal grooves as well as rotary pulleys, wherein at least one of the pulleys includes at least one end cap, a stack (E) of identical crowns, means of connecting crowns and the cap, parallel to a rotational axis (X10) of the pulley and rotating about this axis, wherein the cap defines a hollow housing in which half of the adjacent crown is engaged on one side of a median plane of this crown.

10. A method for producing a transmission pulley for a power transmission system (S) a belt having longitudinal grooves as well as rotary pulleys, wherein at least one of the pulleys includes at least one end cap, a stack (E) of identical crowns, means of connecting crowns and the cap, parallel to a rotational axis (X10) of the pulley and rotating about this axis, and wherein the cap defines a hollow housing in which half of the adjacent crown is engaged on one side of a median plane of this crown; and comprises the following steps:
a) determining the number of longitudinal grooves of the belt,
b) forming a stack (E) of identical crowns with a number of crowns selected depending on the number of grooves of the belt, and
c) connecting the stack (E) of crowns with at least one end cap.
